(19) United States
(12) Patent Application Publication
(10) Pub. No.: US 2012/0261152 A1
(43) Pub. Date: Oct. 18, 2012

(54) AUTO HAMMER

(75) Inventor: Gan Wei, Nanjing (CN)

(73) Assignee: CHERVON (HK) LIMITED, Wanchai (HK)

(21) Appl. No.: 13/445,405

(22) Filed: Apr. 12, 2012

(30) Foreign Application Priority Data
Apr. 13, 2011 (CN) 201110091474.8
Apr. 13, 2011 (CN) 201110091475.2
Apr. 13, 2011 (CN) 201110091552.4
Apr. 13, 2011 (CN) 201110091659.9

(51) Int. Cl. B25D 11/04

(52) U.S. Cl. 173/122

(57) ABSTRACT

An auto hammer includes a housing supporting a striking device, a motor arranged in the housing, a transmission mechanism driven by the motor and an impact assembly. The impact assembly includes an impact wheel and an intermediate shaft for supporting the impact wheel where an impact portion of the impact wheel is provided for impacting on a striking shaft of the striking device. The intermediate shaft is supported on a first supporting member and a second supporting member which are located at the opposite sides of the impact assembly. The axis of the intermediate shaft is substantially perpendicular to the output axis of the motor, and the proportion of the axial length of the intermediate shaft to the diameter of the motor is in a range of approximately 1 to 1.4.

### RELATED APPLICATION INFORMATION

This application claims the benefit of CN 201110091474.8, filed on Apr. 13, 2011, CN 201110091475.2, filed on Apr. 13, 2011, CN 201110091659.9, filed on Apr. 13, 2011, and CN 201110091552.4, filed on Apr. 13, 2011, the disclosures of which are incorporated herein by reference in its entirety.

### BACKGROUND

The following generally relates to an electric tool and, more particularly, to an auto hammer for striking fasteners such as nails etc.

Auto hammers are commonly used portable tools, which have various types. According to the type of the power source utilized, auto hammers may be generally divided into two types: pneumatic and electric. The pneumatic auto hammer needs to be additionally equipped with a compressed air source, thus its use is limited. The basic structure of the electric auto hammer can be summarized as follows: a motor arranged in the gun body is connected to a nailing rod arranged at the gun head via a rotation-linear motion transmission mechanism, thus electrical energy is converted into mechanical energy for the reciprocating motion under the control of a switch.

Both U.S. Pat. No. 6,431,430 and PCT Publication No. WO 2006/008546 disclose an electric auto hammer which uses a slider-crank mechanism as the rotation-linear motion transmission mechanism and a battery as the power source. One problem existing in such electric auto hammer is that the slider-crank mechanism cannot achieve a real striking action, which is a nail pushing mechanism actually. The efficiency of pushing actions is far less than that of striking actions. Secondly, the slider-crank mechanism pushes the nail-pushing element to travel the same distance during each pushing process. When the nail contacts a hard object and then meets a large resistance during traveling, the rotation of the motor may be easily blocked, which may damage the motor. Thirdly, the motor is arranged on the front side or the rear side of the handle, and connected to the transmission mechanism, which takes up a large amount of space so that the electric auto hammer has a large volume and it is not convenient to carry and operate. Chinese Patent No. 1769010 discloses an electric auto hammer which converts the rotation of the motor into an acting force for compressing a spring by a rack and pinion mechanism. Then the compressed spring is released by a disengaging mechanism whereby a striking force is created. Although this electric auto hammer achieves an instant striking force for the nail by means of the spring energy storage, it can only strike once for one time of operation and cannot strike continuously. Moreover, the efficiency of the striking force caused by the spring releasing energy is not high. Thus, this electric auto hammer is not suitable to be frequently used as a conventional tool. In addition, its motor is arranged in the housing below the gun head and separated from the handle, thus it still has a problem that the structure is not compact.

### SUMMARY

Regarding the above defects existing in the prior art, the following describes an auto hammer with a compact structure.

The subject auto hammer comprises a housing supporting a striking device; a motor arranged in the housing, a transmission mechanism driven by the motor and an impact assembly; the impact assembly comprising an impact wheel and an intermediate shaft for supporting the impact wheel, an impact portion of the impact wheel for impacting on a striking shaft of the striking device, the intermediate shaft being supported on a first supporting member and a second supporting member which are located at the opposite sides of the impact assembly, wherein the axis of the intermediate shaft is substantially perpendicular to the output axis of the motor, and the proportion of the axial length of the intermediate shaft to the diameter of the motor is in a range of 1 to 1.4.

A spring element may be arranged between the impact wheel and the first supporting member, and the spring element and the first supporting member may overlap in the axial direction of the intermediate shaft.

The transmission mechanism may comprise a first transmission member and a second transmission member where the first transmission member is drivingly connected to the intermediate shaft and the second supporting member and the mounting axis of the second transmission member are located at the same side of the first transmission member.

The second supporting member and the mounting axis of the second transmission member may be located between the first transmission member and the impact wheel of the impact assembly.

The first supporting member may have a first end adjacent to the impact wheel and a second end away from the impact wheel, and the spring element may have one end that bears against a portion of the first supporting member between the first end and the second end thereof.

One or more spring elements may be provided.

The transmission mechanism may comprise a first transmission member drivingly connected to the intermediate shaft and a second transmission member having an axis parallel to that of the first transmission member.

The transmission mechanism may comprise a first transmission member and a second transmission member where the first transmission member is drivingly connected to the intermediate shaft and the second supporting member and the second transmission member are located at the same side of the first transmission member.

The second transmission member and the second supporting member may be located between the first transmission member and the impact wheel of the impact assembly.

With the above technical solution, on one hand, the described auto hammer can provide a periodic, continual striking force for fasteners such as nails and, on the other hand, the whole tool has a compact structure and small size. Particularly, the distances between the centre of the striking shaft and the two sides of the housing are relatively smaller, thus the subject auto hammer can be used to strike nails in a narrow space, for example, at the corner functionally.

### BRIEF DESCRIPTION OF THE DRAWINGS

FIG. 1 is a schematic view of an exemplary auto hammer constructed according to the description that follows, wherein one housing-half is removed for clearly showing the inner structure thereof;

FIG. 2 is a part sectional schematic view taken along line A-A of FIG. 1, showing one embodiment of the structures of the members in the housing;

FIG. 3 shows another embodiment of the structures of the members;

FIG. 4 shows yet another embodiment of the structures of the members; and

FIG. 5 is a part sectional schematic view taken along line A-A of FIG. 1, showing yet another embodiment of the structures of the members in the housing.

### DETAILED DESCRIPTION

Exemplary auto hammers will now be described with reference to the drawings.

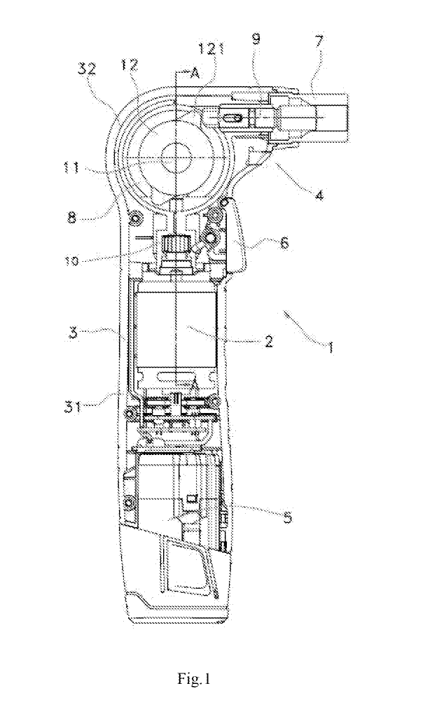

As shown in FIG. 1, which is a schematic view of an auto hammer 1, the auto hammer 1 includes a housing 3 which is formed by two housing-halves mated together. The housing 3 has a body portion and a longitudinally extending gripping handle 31. The gripping handle 31 is provided with a switch 6 for controlling a motor arranged in the housing 3. The housing 3 is provided with a DC battery pack 5 at its lower end and with a nozzle portion 4 at its upper end, head portion 32. The nozzle portion 4 is accommodated with a striking device 7 for striking fasteners such as nails etc.

In the present embodiment, the battery pack 5 is arranged substantially coaxial with the gripping handle 31. At the mating area between the casing of the battery pack 5 and the housing 3, the outer surfaces of both are smoothly connected. At least one portion of the battery pack 5 is inserted into the housing 3, so that the connection between the battery pack 5 and the housing 3 is more stable. In other embodiments, the battery pack 5 of the electric auto hammer can be arranged parallel or perpendicular to the direction of the longitudinal axis of the gripping handle 31. It is not limited to be supplied by DC battery pack, and AC power supply is feasible.

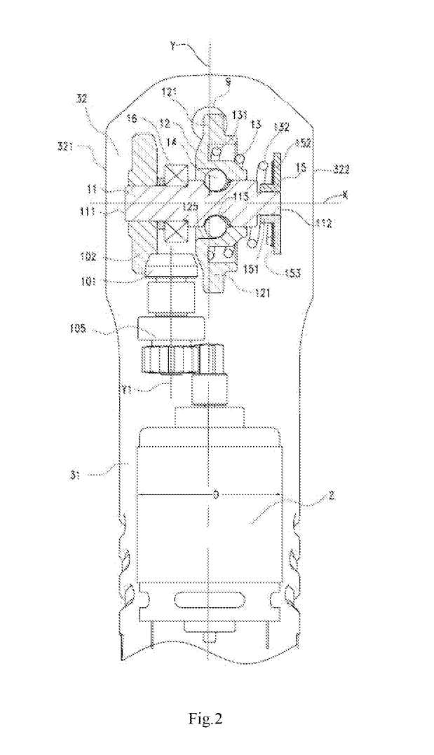

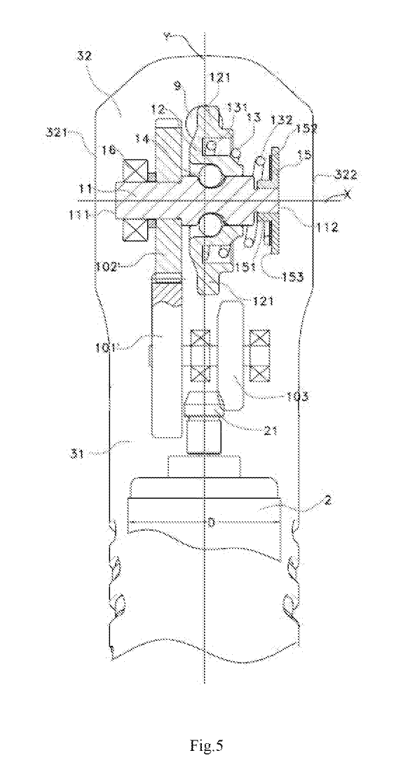

After one housing-half 3 is removed, the internal structures of the auto hammer may be clearly shown. The housing 3 is accommodated with a motor 2 therein, and the rotating motion of the motor 2 is converted into the striking motion of the striking device 7 by a transmission mechanism 10. Referring to FIG. 2-4, the transmission mechanism 10 comprises a gear transmission portion which can turn around a shown axis, and an impact assembly 8 for impacting the striking device 7. The striking device 7 includes a striking shaft 9 which can perform a reciprocating rectilinear motion. The impact assembly 8 includes an impact wheel 12 and an intermediate shaft for supporting the impact wheel 12. In the present embodiment, the intermediate shaft is arranged as a rotating shaft 11 which can be rotatably supported in the head portion 32. In other embodiments, the intermediate shaft may also be a stationary shaft. The rotating shaft 11 and the impact wheel 12 have a common rotating axis X that is perpendicular to an output axis Y of the motor. The rotating shaft 11 is supported in the head portion 32 by two supporting members at opposite ends thereof, and driven by a transmission output member of the transmission mechanism 10. In the present embodiment, the rotating shaft 11 is fixedly connected to the transmission output member of the transmission mechanism 10. While in other embodiments, the rotating shaft 11 may be integrated with the transmission output member (not shown). The impact wheel 12 is substantially hollow plate-shaped, and encloses the rotating shaft 11 via its hollow portion. The impact wheel 12 is provided with at least one impact portion 121, preferably two impact portions 121 which are arranged symmetrically with respect to the rotating axis X and protrude outwards from the outer circumference of the impact wheel 12. During the rotation of the impact wheel 12 driven by the rotating shaft 11, the impact portion 121 of the impact wheel 12 strikes the stricken portion of the striking shaft 9 periodically in succession. So the front end of the striking shaft 9 strikes fasteners such as nails or the like periodically in succession. Thus the fastener is stricken into a work piece gradually.

At the engaging portions of the rotating shaft 11 and the impact wheel 12, a pair of inclined slots 115 inclined relative to the axis direction and a pair of guide slots 125 corresponding to the inclined slots 115 in position are formed respectively on the outer cylindrical surface of the rotating shaft 11 and the inner cylindrical surface of the impact wheel 12. A pair of steel balls 14 are respectively arranged in a cavity formed together by the inclined slot 115 and guide slot 125, and can move with the cavity varied in position due to the change of the relative position of the slanting slots 115 and the guide slots 125. As a result, when the rotating shaft 11 is rotated, the impact wheel 12 can be driven to rotate through the steel balls 14 exerting a pressure to the guide slots 125. An energy storage spring 13 is mounted in the housing 3, with one end 132 thereof being fixed in position and the other end 131 thereof abutting against one side of the impact wheel 12. The energy storage spring 13 exerts a thrust force towards the impact wheel 12 along the axis direction of the impact wheel 12. Thus, when the rotating shaft 11 and the impact wheel 12 remain at rest or run idle, the steel balls 14 are located at the top of the inclined slots 115 and the bottom of the guide slots 125, and the impact wheel 12 is located in a first axial position relative to the rotating shaft 11. When the motor is started, the impact wheel 12 is rotated together with the rotating shaft 11 until the impact portion 121 of the impact wheel 12 strikes the striking shaft 9, whereby a strike to the striking shaft 9 is achieved. Then a further rotation of the impact wheel 12 would be temporarily stopped due to the stricken end of the striking shaft 9 contacting with the impact wheel 12. The impact wheel 12 would be forced to move axially relative to the rotating shaft 11 towards a second position where the energy storage spring 13 is compressed under the action of the slots 115, 125 and the steel balls 14 therein. When the impact wheel 12 is moved and departs from contacting with the striking shaft 9, the stopping is then released. At this moment, the energy storing spring 13 releases the elastic potential energy thereof. Under the function of the rebound force of the energy storing spring 13, the impact wheel 12 is axially moved back to its first axial position, and a high speed rotation which exceeds the rotating shaft 11 in speed will be produced with the cooperation of the inclined slots 115, the guiding slots 125 and the steel balls 14. As a result, the stricken end of the striking shaft 9 is impacted by the impact portion 121 of the impact wheel 12 to strike the nail again at high efficiency, and thus another strike action is achieved.

As shown in FIG. 2, the striking shaft 9 of the striking device 7 is generally located at the right middle position of the head portion 32, and the distances from the two sides 321, 322 of the head portion 32 to the striking shaft 9 are substantially the same. The rotating shaft 11 of the impact assembly 8 is transversely supported in the head portion 32 in the direction perpendicular to the axis of the striking shaft, and the two ends of the rotating shaft 11 corresponds to the two sides 321 and 322 of the head portion 32 in position respectively. Thus, the width between the two sides of the head portion 32 is directly dependent on the transverse dimension of the rotating shaft 11. The rotating shaft 11 is rotatably supported by first and second supporting members. In the present embodiment, the first and the second supporting members are provided by a first bearing 15 and a second bearing 16 respectively. The first bearing 15 has a first end 151 adjacent to the impact wheel 12 and a second end 152 away from the impact wheel 12. The energy storage spring 13 has one end which is supported at a portion 153 between the first end 151 and the second end 152 of the first bearing 15. In the present embodiment, the portion 153 is configured as a stepped surface lower than the end surface of the first end 151. However, in other embodiments, the portion 153 may be configured in other forms. Hence, any variation or modification may fall into the scope of the concept of the present embodiment, as long as the portion 153 is lower than the first end 151 so as to form a concave structure for the energy storage spring 13 to be inserted in.

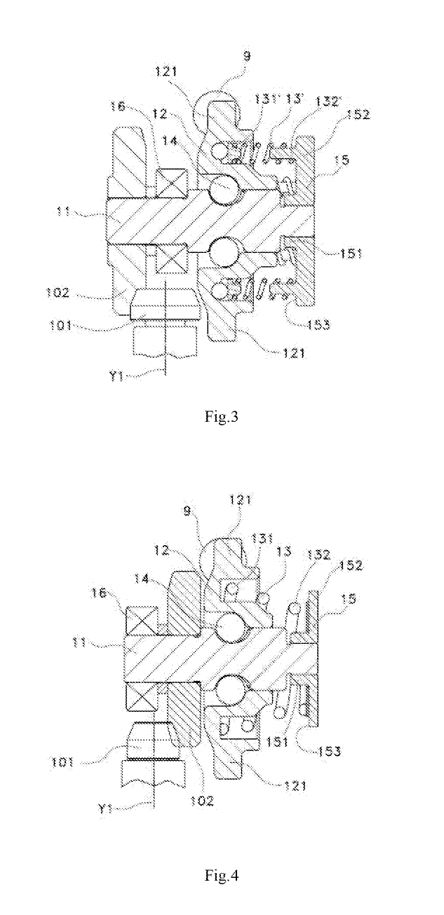

Referring to FIG. 3, several energy storage springs 13 may be used and are symmetrically distributed on the periphery of the rotating shaft 11 relative to the axis of the rotating shaft 11. The first end 151 of the first bearing 15 extends into the hollow space encircled by the several energy storage springs 13, so that the first bearing 15 and the energy storage springs 13 overlap in the axial direction of the rotating shaft 11. Due to the overlap in size, a more compact structure can be obtained. Meanwhile, the length between the first end 151 and the second end 152 of the first bearing 15 is enough for supporting the rotating shaft 11, thus a more stable support can be obtained and is not easy to wear. Referring to FIG. 2, when the energy storage spring 13 is provided by a large spring, the first end 151 of the first bearing 15 extends into the hollow space formed by the body of the large spring. Similarly, the energy storage spring 13 and the first bearing 15 have an overlap in the direction of the axis of the rotating shaft 11, thus a compact structure is obtained, and the repetitious details need not be given here.

Referring to FIGS. 2-4, in one exemplary embodiment, the transmission mechanism 10 is drivingly connected with the rotating shaft 11 and is provided with a large bevel gear 102 for transmission output and a small bevel gear 101 engaged with the large bevel gear 102. The second bearing 16 and the mounting axis Y1 of the small bevel gear 101 are located at the same side of the large bevel gear 102. The second bearing 16 is located in a space formed by the small bevel gear 101 in its radial direction, which enables the structure in the housing to be more compact. Further, referring to FIG. 2 and FIG. 3, the second bearing 16 and the mounting axis Y1 of the small bevel gear 101 are both located between the large bevel gear 102 and an impact wheel 12. With this arrangement, the other transmission components 105 installed coaxially with the small bevel gear 101 may even be configured in such way that all of the components would not go beyond the scope of the diameter D of the housing of the motor.

FIG. 5 shows another exemplary embodiment. The transmission mechanism 10 is drivingly connected with the rotating shaft 11 and may be provided by a first cylinder gear 102′ for transmission output and a second cylinder gear 101′ engaged with the first cylinder gear 102′. The transmission portion for turning the transmission mechanism is provided by the small bevel gear 21 on the output shaft of the motor and the large bevel gear 103 engaged with the small bevel gear 21. Due to the rotating central axis of the first cylinder gear 102′ being parallel to that of the second cylinder gear 101′, the inner structure is more compact, and the transverse width between the two sides 321, 322 of the head portion 32 is smaller, thus the hammer is more suitable for striking the fasteners in a narrow space.

With the above embodiments, the electric auto hammer of the present invention may be configured to have a small size and a compact inner structure. In particular, the rotating shaft 11 has an axial length in the direction of the axis X thereof. The axial length may be defined by the distance between a left end surface 111 and a right end surface 112 of the rotating shaft 11. The proportion of the axial length of the rotating shaft 11 to the diameter D of the motor 2 may be less than 1.4. When the axial length of the rotating shaft 11 is equal to the diameter D of the motor 2, that is to say, the proportion of the axial length of the rotating shaft 11 to the diameter D of the motor 2 is 1, the head portion 2 for accommodating the rotating shaft 11 therein is substantially level with the surface of the housing of the gripping handle 31 for accommodating the motor 2 therein.

The auto hammers disclosed herein are not limited to the contents described in the above embodiments and the structures shown in the drawings. Based on the subject disclosure, any obvious changes, replacements or modifications for the shape and position of the members will be regarded as falling within the protection scope of the present invention.

What is claimed is:

1. An auto hammer, comprising:
a housing;
a motor with a diameter arranged in the housing,;
a transmission mechanism driven by the motor;
a striking device including a striking shaft, which is supported in the housing; and
an impact assembly, wherein the impact assembly comprises an impact wheel and an intermediate shaft with an axial length for supporting the impact wheel, the impact wheel is provide with an impact portion for impacting the striking shaft of the striking device, the intermediate shaft being supported on a first supporting member and a second supporting member which are located at the opposite sides of the impact assembly, wherein an axis of the intermediate shaft is substantially perpendicular to an output axis of the motor,
wherein the proportion of the axial length of the intermediate shaft to the diameter of the motor is in an approximate range of 1-1.4.

2. The auto hammer of claim 1, wherein a spring element is arranged between the impact wheel and the first supporting member, and the spring element and the first supporting member overlap in the axial direction of the intermediate shaft.

3. The auto hammer of claim 2, wherein the transmission mechanism comprises a first transmission member and a second transmission member, wherein the first transmission member is drivingly connected to the intermediate shaft and wherein the second supporting member and a mounting axis of the second transmission member are located at the same side of the first transmission member.

4. The auto hammer of claim 3, wherein the second supporting member and the mounting axis of the second transmission member are located between the first transmission member and the impact wheel of the impact assembly.

5. The auto hammer of claim 1, wherein the first supporting member has a first end adjacent to the impact wheel and a second end distal from the impact wheel, and the spring element has one end for bearing against a portion of the first supporting member between the first and second ends of the first supporting member.

6. The auto hammer of claim 5, wherein one or more spring elements are provided.

7. The auto hammer of claim 1, wherein the transmission mechanism comprises a first transmission member drivingly connected to the intermediate shaft and a second transmission member having an axis parallel to that of the first transmission member.

8. The auto hammer of claim 1, wherein the transmission mechanism comprises a first transmission member and a second transmission member, wherein the first transmission member is drivably connected to the intermediate shaft and wherein the second supporting member and the second transmission member are located at the same side of the first transmission member.

9. The auto hammer of claim 8, wherein the second transmission member and the second supporting member are located between the first transmission member and the impact wheel of the impact assembly.
